(19) United States
(12) Patent Application Publication
(10) Pub. No.: US 2025/0225751 A1
(43) Pub. Date: Jul. 10, 2025

(54) SYSTEM AND METHOD FOR HEAD MOUNT DISPLAY REMOVAL PROCESSING

(71) Applicant: CANON KABUSHIKI KAISHA, Tokyo (JP)

(72) Inventors: Xiwu Cao, Irvine, CA (US); Floyd Albert Maseda, Tustin, CA (US); Li-Ju Chen, Irvine, CA (US); Rui Xu, Alhambra, CA (US); Brian That Ton, Irvine, CA (US); Bradley Scott Denney, Irvine, CA (US)

(21) Appl. No.: 19/009,811

(22) Filed: Jan. 3, 2025

Related U.S. Application Data
(60) Provisional application No. 63/618,058, filed on Jan. 5, 2024.

(51) Int. Cl. G06T 19/20; G06T 3/40; G06T 7/33; G06T 7/73; G06T 19/00; G06V 10/25; G06V 10/74; G06V 20/20

(52) U.S. Cl. CPC G06T 19/20; G06T 3/40; G06T 7/344; G06T 7/75; G06T 19/006; G06V 10/25; G06V 10/761; G06V 20/20; G06T 2207/20221; G06T 2219/2004

(57) ABSTRACT

An image processing method and apparatus is provided that includes receiving two consecutive image frames captured live by an image capture apparatus, each of the two image frames including a subject wearing a head mount display device, generate a first bounding box surrounding the head mount display device using orientation information obtained from the head mount display, generate a second bounding box surrounding the head mount display using an object detection model trained to identify the head mount display, calculate a difference indicator by comparing differences, on a pixel by pixel basis between the generated first and second bounding boxes, select the first bounding box when it is determined that the difference indicator exceeds a predetermined threshold, provide coordinates representing the first bounding box to identify a region within the images to be replaced by a region of a precaptured image that is occluded by the head mount display device.

### CROSS-REFERENCE TO RELATED APPLICATIONS

This nonprovisional application claims priority from U.S. Provisional Patent Application Ser. No. 63/618,058 filed on Jan. 5, 2024 which is incorporated herein by reference in its entirety

### BACKGROUND

### Technical Field

The present disclosure relates generally to video image processing in a virtual reality environment.

### Description of Related Art

Given the progress that has been recently made in mixed reality, it is becoming practical to use a headset or Head Mounted Display (HMD) to join a virtual conference or a get-together meeting and be able to see each other with 3D faces in real-time. The need for these gatherings has been made more important because, in some scenarios such as a pandemic or other disease outbreaks, people cannot meet together in person.

Headsets are needed so we are able to see the 3D faces of each other using virtual and/or mixed reality. However, with the headset positioned on the face of a user, no one can really see the entire 3D face of others because the upper part of the face will be blocked by the headset. Therefore, to find a way to remove the headset and recover the blocked upper face region from the 3D faces is critical to the overall performance in virtual and/or mixed reality.

### SUMMARY

According to the present disclosure, an image processing method implemented by one or more information processing apparatus is provided which includes receiving two consecutive image frames captured live by an image capture apparatus, each of the two image frames including a subject wearing a head mount display device, generate a first bounding box surrounding the head mount display device using orientation information obtained from the head mount display, generate a second bounding box surrounding the head mount display using an object detection model trained to identify the head mount display, calculate a difference indicator by comparing differences, on a pixel by pixel basis between the generated first and second bounding boxes, select the first bounding box when it is determined that the difference indicator exceeds a predetermined threshold, provide coordinates representing the first bounding box to identify a region within the images to be replaced by a region of a precaptured image that is occluded by the head mount display device.

In another embodiment, the image processing operations according to the present disclosure includes generating the first bounding box is performed using a camera model characterizing a relationship between the head mount display device in three dimensions and a two dimensional image projection of the head mount display device.

In another embodiment, the image processing operations according to the present disclosure includes using the provided coordinates to replace the identified region with a corresponding region of the precaptured image and generating a composite image that includes the subject appearing without the head mount display device and including the replaced region from the precaptured image.

In another embodiment, the image processing operations according to the present disclosure includes aligning a first coordinate system associated with an image capture device with a second coordinate system associated with the head mount display device, and using the aligned coordinate systems in replacing a portion of the image frame that includes the head mount display device with a region of a precaptured image of the subject.

In another embodiment, the image processing operations according to the present disclosure includes receiving an image frame of a subject wearing a head mount display device, determining a first alignment parameter that aligns the first coordinate system with the second coordinate system based on replacing a portion of the subject occluded by the head mount display device with features of the subject derived from a precaptured image, determining a second alignment parameter using the first alignment parameter as an initial value and using a camera model, determining whether the second alignment parameter is valid by determining an accuracy of the camera model, and using the second alignment parameter when it is determined that the camera model is accurate and use the first alignment parameter when it is determined that the camera model is not accurate.

In another embodiment, the image processing operations according to the present disclosure includes generating a composite image that includes the subject appearing without the head mount display device and including the replaced region from the precaptured image, and scaling the generated image to appear correctly proportional to an image in a shared virtual reality environment, causing the scaled image to be displayed on a display of the head mount display being worn by the subject and on the head mount display of other subjects concurrently in the virtual reality environment.

In another embodiment, the image processing operations according to the present disclosure includes obtaining a plurality of images having a first scale factor determined using a camera model, obtaining a plurality of image having a second scale factor using a scaling model other than a camera model, comparing values of the first and second scale factors, generating a plot representing first and second scale factors that differ by a predetermined threshold, converting the first scale factor to have a magnitude substantially similar to a magnitude of the second scale factor based on a linear regression of the generated plot, and causing the scaled images to be displayed in the shared virtual reality environment using the converted scale factor.

In other embodiments, a system is provided that includes a head mount display device configured to be worn by a subject, an image capture device configured to capture real time images of the subject wearing the head mount display device and an information processing apparatus one or more memories storing instructions; and one or more processors that, upon execution of the stored instructions, are configured to perform any of the image processing methods described in the present disclosure.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a virtual reality capture and display system according the present disclosure.

FIG. 2 shows an embodiment of the present disclosure.

FIG. 3 shows a virtual reality environment as rendered to a user according to the present disclosure.

FIG. 4 illustrates a block diagram of an exemplary system according to the present disclosure.

FIG. 5 illustrates HMD removal processing according to the present disclosure.

FIGS. 6A & 6B illustrate exemplary HMD removal pipeline processing performed according to the present disclosure.

FIG. 7A depicts a camera model-based HMD removal according to the present disclosure.

FIG. 7B is an illustration of a HMD device with its 3D position and orientation being shown.

FIG. 8 describes the application of the camera model according to the present disclosure to each step in the HMD removal processing.

FIG. 9 is a flow diagram detailing an algorithm for using the camera model to aid in HMD removal.

FIG. 10 illustrates image frames used in the processing described in FIG. 9.

FIG. 11 illustrates how utilizing a camera model can enhance the process of image cropping.

FIG. 12 describes an algorithm for using the camera model to improve alignment between the image capture device (e.g. mobile phone) and the HMD device.

FIG. 13 describes an algorithm for using the camera model to improve alignment between the image capture device (e.g. mobile phone) and the HMD device.

FIG. 14 depicts limitations from using only an image for scaling purposes in a VR environment.

FIGS. 15A & 15B illustrate using the camera model to determine scale factors in a VR environment.

FIG. 16 is a flow diagram detailing an algorithm for using the camera model to aid in scaling a user in VR.

FIG. 17 are two scatter plots showing data collected during the processing performed in FIG. 16.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

### Section 1: Environment Overview

The present disclosure as shown hereinafter describes systems and methods for implementing virtual reality-based immersive calling.

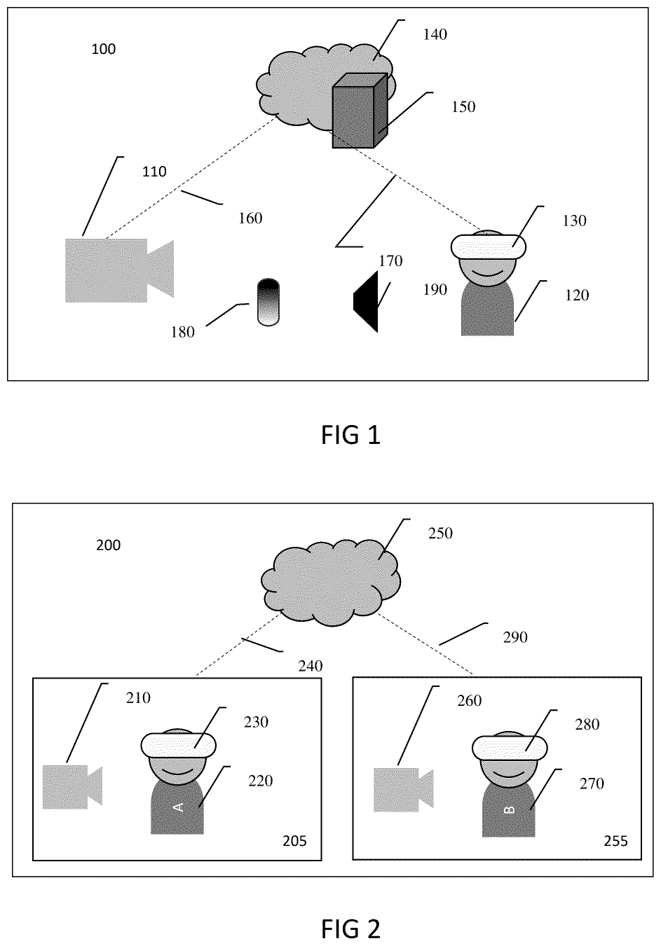

FIG. 1 shows a virtual reality capture and display system 100. The virtual reality capture system comprises a capture device 110. The capture device may be a camera with sensor and optics designed to capture 2D RGB images or video, for example. In one embodiment, the image capture device 110 is a smartphone that has front and rear facing cameras and which can display images captured thereby on a display screen thereof. Some embodiments use specialized optics that capture multiple images from disparate view-points such as a binocular view or a light-field camera. Some embodiments include one or more such cameras. In some embodiments the capture device may include a range sensor that effectively captures RGBD (Red, Green, Blue, Depth) images either directly or via the software/firmware fusion of multiple sensors such as an RGB sensor and a range sensor (e.g., a lidar system, or a point-cloud based depth sensor). The capture device may be connected via a network 160 to a local or remote (e.g., cloud based) system 150 and 140 respectively, hereafter referred to as the server 140. The capture device 110 is configured to communicate via the network connect 160 to the server 140 such that the capture device transmits a sequence of images (e.g., a video stream) to the server 140 for further processing.

Also, in FIG. 1, a user 120 of the system is shown. In the example embodiment the user 120 is wearing a Virtual Reality (VR) device 130 configured to transmit stereo video to the left and right eye of the user 120. As an example, the VR device may be a headset worn by the user. As used herein, the VR device and head mounted display (HMD) device may be used interchangeably. Other examples can include a stereoscopic display panel or any display device that would enable practice of the embodiments described in the present disclosure. The VR device is configured to receive incoming data from the server 140 via a second network 170. In some embodiments the network 170 may be the same physical network as network 160 although the data transmitted from the capture device 110 to the server 140 may be different than the data transmitted between the server 140 and the VR device 130. Some embodiments of the system do not include a VR device 130 as will be explained later. The system may also include a microphone 180 and a speaker/headphone device 190. In some embodiments the microphone and speaker device are part of the VR device 130.

FIG. 2 shows an embodiment of the system 200 with two users 220 and 270 in two respective user environments 205 and 255. In this example embodiment, each user 220 and 270 are equipped with a respective capture devices 210 and 260, respective VR devices 230 and 280, and are connected via respective networks 240 and 270 to a server 250. In some instances, only one user has a capture device 210 or 260, and the opposite user may only have a VR device. In this case, one user environment may be considered as a transmitter and the other user environment may be considered the receiver in terms of video capture. However, in embodiments with distinct transmitter and receiver roles, audio content may be transmitted and received by only the transmitter and receiver or by both, or even in reversed roles.

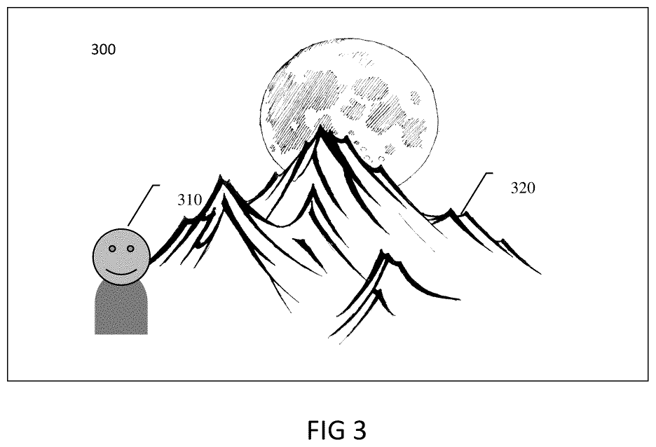

FIG. 3 shows a virtual reality environment 300 as rendered to a user. The environment includes a computer graphic model 320 of the virtual world with a computer graphic projection of a captured user 310. For example, the user 220 of FIG. 2, may see via the respective VR device 230, the virtual world 320 and a rendition 310 of the second user 270 of FIG. 2. In this example, the capture device 260 would capture images of user 270, process them on the server 250 and render them into the virtual reality environment 300.

In the example of FIG. 3, the user rendition 310 of user 270 of FIG. 2, shows the user without the respective VR device 280. The present disclosure sets forth a plurality of algorithms that, when executed, cause the display of user 270 to appear without the VR device 280 and as if they were captured naturally without wearing the VR device. Some embodiments show the user with the VR device 280. In other embodiments the user 270 does not use a wearable VR device 280. Furthermore, in some embodiments the captured images of user 270 capture a wearable VR device, but the processing of the user images removes the wearable VR device and replace it with the likeness of the users face.

Additionally, the addition of the user rendition 310 into the virtual reality environment 300 along with VR content 320 may include a lighting adjustment step to adjust the lighting of the captured and rendered user 310 to better match the VR content 320.

In the present disclosure, the first user 220 of FIG. 2, is shown via the respective VR device 230, the VR rendition 300 of FIG. 3. Thus, the first user 220, sees user 270 and the virtual environment content 320. Likewise, in some embodiments, the second user 270 of FIG. 2, will see in the same VR environment 320, but from a different view-point, e.g. the view-point of the virtual character rendition of 310 for example.

In order to achieve the immersive calling as described above, it is important to render each user within the VR environment as if they were not wearing the headset in which they are experiencing the VR content. The following describes the real-time processing performed that obtains images of a respective user in the real world while wearing a virtual reality device 130 also referred to hereinafter as the head mount display (HMD) device.

### Section 2: Hardware

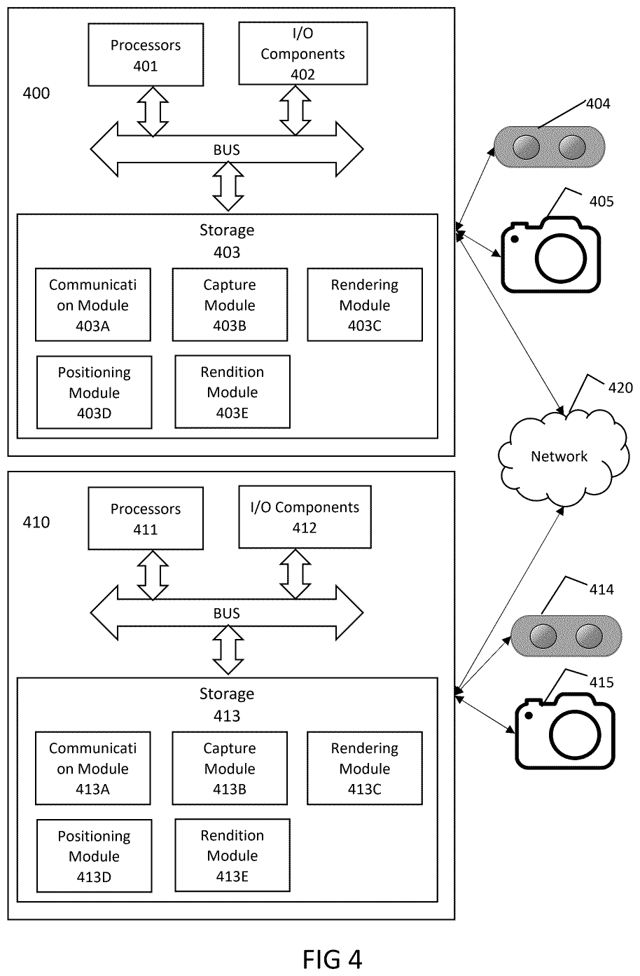

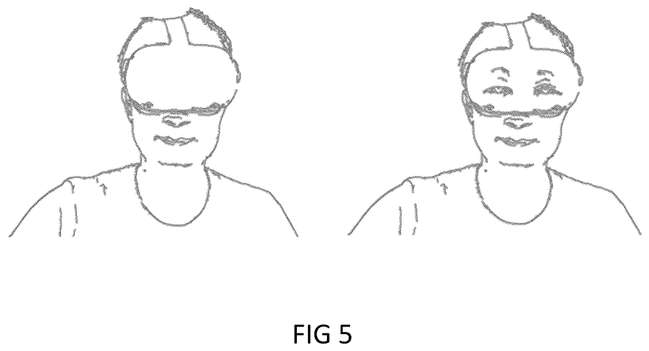

FIG. 4 illustrates an example embodiment of a system for virtual reality immersive calling system. The system includes two user environment systems 400 and 410, which are specially-configured computing devices; two respective virtual reality devices 404 and 414, and two respective image capture devices 405 and 415. In this embodiment, the two user environment systems 400 and 410 communicate via one or more networks 420, which may include a wired network, a wireless network, a LAN, a WAN, a MAN, and a PAN. Also, in some embodiments the devices communicate via other wired or wireless channels.

The two user environment systems 400 and 410 include one or more respective processors 401 and 411, one or more respective I/O components 402 and 412, and respective storage 403 and 413. Also, the hardware components of the two user environment systems 400 and 410 communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 401 and 411 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 402 and 412 include communication components (e.g., a graphics card, a network-interface controller) that communicate with the respective virtual reality devices 404 and 414, the respective capture devices 405 and 415, the network 420, and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storages 403 and $13 include one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storages 403 and 413, which may include both ROM and RAM, can store computer-readable data or computer-executable instructions.

The two user environment systems 400 and 410 also include respective communication modules 403A and 413A, respective capture modules 403B and 413B, respective rendering module 403C and 413C, respective positioning module 403D and 413D, and respective user rendition modules 403E and 413E. A module includes logic, computer-readable data, or computer-executable instructions. In the embodiment shown in FIG. 4, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 403 and 413. Also, in some embodiments, the two user environment systems 400 and 410 includes additional or fewer modules, the modules are combined into fewer modules, or the modules are divided into more modules. One environment system may be similar to the other or may be different in terms of the inclusion or organization of the modules.

The respective capture modules 403B and 413B include operations programed to carry out image capture as shown in 110 of FIGS. 1, 210 and 260 of FIG. 2. The respective rendering module 403C and 413C contain operations programed to carry out the functionality associated with rendering images that are captured to one or more users participating in the VR environment. The respective positioning module 403D and 413D contain operations programmed to carry out the process including identifying and determining position of each respective user in the VR environment. The respective user rendition modules 403E and 413E contains operations programmed to carry out user rendering as illustrated in the following figures described hereinbelow. The prior-training module 403F contains operations programmed to estimate the nature and type of images that were captured prior to participating in the VR environment that are used for the head mount display removal processing. In some embodiments the some modules are stored and executed on an intermediate system such as a cloud server. In other embodiments, the capture devices 405 and 415, respectively, include one or more modules stored in memory thereof that, when executed perform certain of the operations described hereinbelow.

### Section 3: Overview of HMD Removal Processing

As noted above, in view of the progress made in augmented virtual reality, it is becoming more common to enter into an immersive communication session in a VR environment where each user is in their own location wearing a headset or Head Mounted Display (HMD) to join together in virtual reality. However, HMD device has blocked the capability of achieving better user experience if a HMD removal is not applied since you won't see the full face of others while in VR and others are unable to see your full face.

To allow for full visibility of the face of the user being captured by the image capture device HMD removal processing is conducted to replace HMD region with an upper face portion of the image. An example is shown in FIG. 5 to illustrate the effect of HMD removal. We want to replace the HMD region of the HMD image shown on the left with one or more precaptured images of the user or artificially generated images to form a full face image shown on the right. In generating the full face image, the features of the face that are generally occluded when wearing the HMD are obtained and used in generating the full face image such that the eye region will be visible in the virtual reality environment. HMD removal is a critical component in any augmented or virtual reality environment because it improves visual perception HMD region is replaced with some reasonable images of the user that were previously captured.

The precaptured images that are used as replacement images during the HMD removal processing are images obtained using an image capture device such as a mobile phone camera or other camera whereby a user is directed, via instructions displayed on a display device to position themselves in an image capture region and move their face in certain ways and make different facial expressions. These precaptured images may be still or video image data and stored in a storage device. The precaptured images may be cataloged and labeled by the precapture application and stored in a database in association with user specific credentials (e.g. a user ID) so that one or more of these precaptured images can be retrieved and used as replacement images to replace the upper face portion to replace an upper portion of the face image that contains the HMD. This process will be further described hereinafter.

With the recent advancements in mixed reality technology, attending virtual meetings or social gatherings via headsets or Head Mounted Displays (HMDs) is increasingly feasible. While these HMDs facilitate a 3D visual interaction, they will block a full view of the wearer's face, particularly the upper facial region. Therefore, developing a method to eliminate the headset area in the upper facial region and replace it with a reasonable upper face for user is crucial for enhancing the user experience in mixed reality settings.

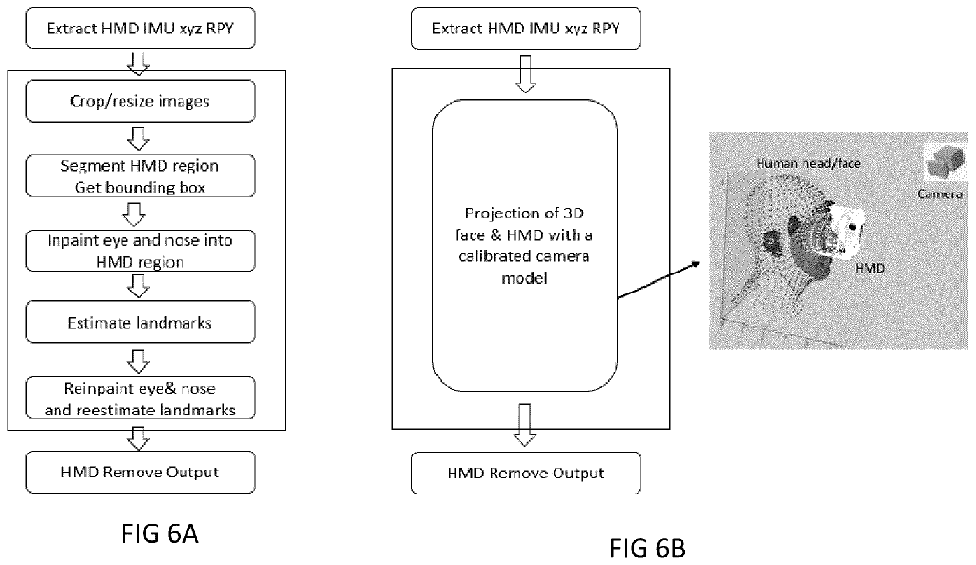

An exemplary HMD removal pipeline is illustrated in FIG. 6A. Upon receiving an HMD image and its corresponding spatial coordinate positions of X, Y, and Z and orientations of Pitch, Yaw and Roll from the IMU sensor, the image is cropped and resized. The HMD area is segmented and determine a bounding box corresponding to the segmented region. An initial inpainting process is performed whereby an initial candidate eyes and nose based on the orientation from the IMU sensor and the 3D head geometry is determined and selected. The initial facial landmarks are estimated using a library database that predicts facial landmarks. In one embodiment, the facial landmarks are estimated using a software library such as Mediapipe. After that, a revised eye and nose area is re-inpainted, and updated facial landmarks are generated accordingly. This information is then used to generate our final HMD removal output. The goal of the whole processes is to obtain correct landmarks for upper face region from the HMD bounding box. Additional explanation of this process can be found in PCT Application Serial No. PCT/US23/77428 which is incorporated herein by reference. An improvement to this processing is illustrated in FIG. 6B.

In one embodiment, information describing a camera model that describes the 3D relationship among a camera that captures live images of a user wearing the HMD device, HMD device and the human face is illustrated in FIG. 6B. As illustrated in FIG. 6B, these processing steps can replace at least one portion of the processing steps illustrated in FIG. 6A. In replacement, the projection of 3D face & HMD through the camera model based on the input of IMU data is used for HMD removal processing shown in FIG. 6B.

The camera model that describes the relationship between the 3D world and its 2D image projection for an HMD device is mathematically represented in equation (1), which outputs a 3D point's 2D image coordinates, (xᵢₘₚ, yᵢₘₚ), from its 3D world coordinates, (X_{3d}, Y_{3d}, Z_{3d}).

$$[ \begin{matrix}{x}_{imp} \\ {y}_{imp} \\ 1\end{matrix} ] = [ \begin{matrix}s & 0 & 0 \\ 0 & s & 0 \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}{X}_{3 d} \\ {Y}_{3 d} \\ {Z}_{3 d} \\ 1\end{matrix} ] \qquad Equation 1$$

The parameters of the camera model are denoted as (s, R, T), where ‘s’ represents the scale, ‘R’ is the rotation matrix with elements r₁₁ to r₃₃, and ‘T’ is the translation vector with elements t₁, t₂, t₃. The estimation of the Camera Model is described as below. In brief, we used the centers of the HMD bounding boxes from multiple frames as the training dataset which contains both 2D image coordinates, (xᵢₘₑ, yᵢₘₑ), estimated using a customized HMD region segmentation model that we trained offline, and projected 2D coordinates, (xᵢₘₚ, yᵢₘₚ), derived using Equation 1 from their corresponding 3D coordinate information obtained through IMU-based rotation and translation on the 3D point cloud in the CAD model. The Camera model (s, R, T) is then estimated based on the mean square error between the estimated 2D HMD center (xᵢₘₑ, yᵢₘₑ) and the projected 2D HMD center (xᵢₘₚ, yᵢₘₚ).

After an initial estimation of the camera model, its parameters will be further tuned by including more frames captured through the pipeline or uniformly selecting frames from different angles. Overall, the final camera model will be estimated by making sure that the camera-based projection of the centers of the bounding boxes of HMD CAD model exactly aligns with its estimation in 2D images. Only when the relationship between the tuned camera model between HMD and camera matches their physical realities, the centers of the projections and the centers of the estimation will align together. Similarly, we can determine the 3D relationship between the HMD and 3D face where the estimated 3D face point clouds are compared to the projected 3D face point clouds to adjust the 3D relationship between HMD and face.

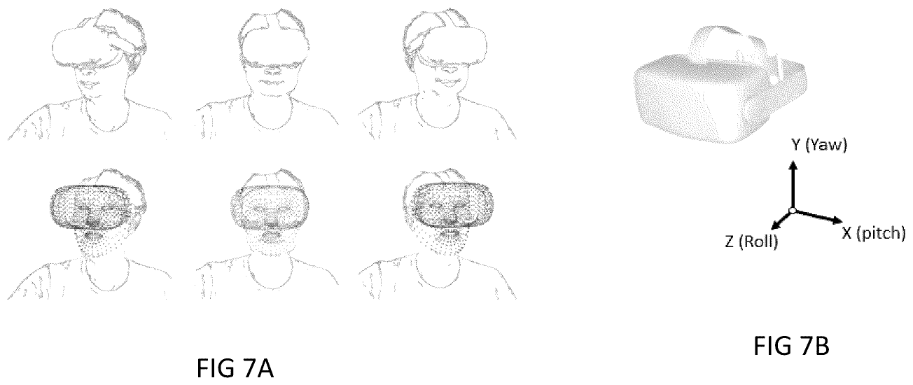

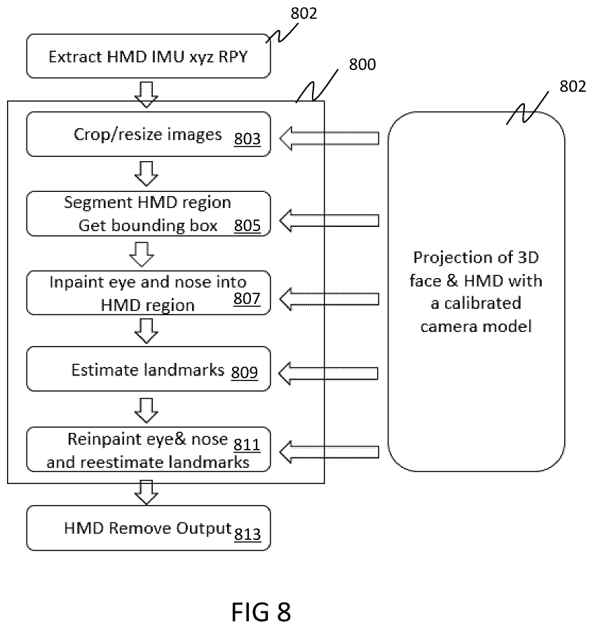

One example of how HMD removal is fully performed using a camera model is shown in FIG. 7A. When a user wearing HMD turns their head in different orientations, the 2D projection of both the HMD and face is automatically generated based on the estimated camera model and the movement of HMD device. The movement of HMD can be extracted from the IMU sensor inside the HMD. An illustration of a HMD device with its 3D position and orientation is shown in FIG. 7B.

Although a fully camera model-based pipeline for HMD removal is ideal, it faces several practical challenges. The first issue is that our camera model is often estimated based on features extracted from real images. These estimations can introduce errors into the data, potentially generating an ineffective camera model and causing the HMD removal process to fail. The second issue relates to an assumption associated with using pinhole camera model for the estimation. The pinhole model is a simplified representation of a camera. There are numerous cases where the projection of 3D objects or landmarks cannot be accurately captured using a pinhole camera model. In such scenarios, the estimated model fails to account for variations in depth or object translation within the 3D domain.

To address these concerns, a camera model-assisted HMD removal pipeline is described. In this scheme, HMD removal does not rely solely on the camera model to replace all pre-existing steps in image processing to obtain the final projection of the 3D face and face mask. Instead, the camera model is used to assist each step in the HMD removal pipeline by advantageously correcting all those outlier estimates during the detection of each component. An illustration of this approach is shown in FIG. 8.

As shown in FIG. 8. a trained camera model 802 is stored in memory and receives input image frame data in order to output predictions representing projections of the 3D face images and the HMD. As will be described hereinafter, each processing element of the HMD removal pipeline 800 is assisted when data associated with the respective aspect of the HMD removal pipeline are provided to and processed using the camera model 802. As previously described above with respect to FIG. 6A, HMD data 801 is data generated by one or more sensors of the HMD device being worn by the user. The HMD data includes the HMD image and its corresponding spatial coordinate positions of X, Y, and Z and orientations of Pitch, Yaw and Roll from the IMU sensor. This HMD data is input into a first stage of the pipeline where crop/resizing processing is performed in 803. Segmentation processing is performed in 805 where the HMD area is segmented and a bounding box corresponding to the segmented region is determined. In 807, initial inpainting processing is performed whereby an initial candidate eyes and nose based on the orientation from the IMU sensor and the 3D head geometry is determined and selected from a set of user-specific images stored in an image database. In one embodiment, these candidate images are captured and stored in a pre-capture processing (not illustrated) whereby an application executing on an image capture device such a mobile phone or table directs a user to pose in various positions and head orientations to capture candidate images. The candidate images may be selected based on the live image of the user being captured as noted by the orientation and position of the user's head for the inpainting processing. In 809, processing is performed to estimate initial facial landmarks using a library database that predicts facial landmarks based on received images. In this case, the initial inpainted images are used as the basis for the initial estimation processing 809. In 811, a revised eye and nose area is re-inpainted, and updated facial landmarks are generated accordingly. This information is then used to generate our final HMD removal output in 813.

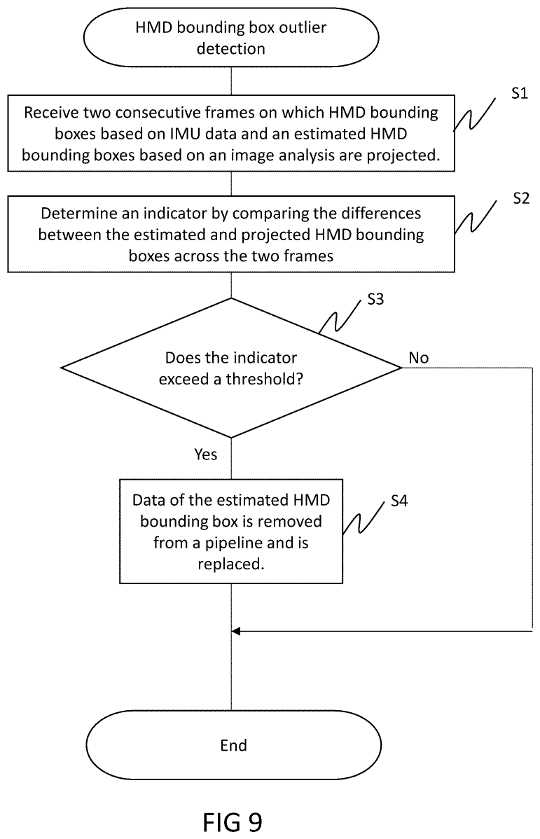

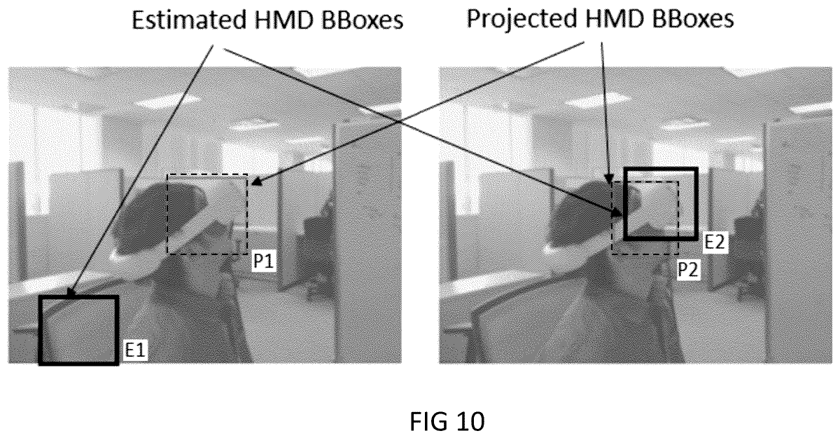

Turning now to the individual aspects of the FIG. 8 that are assisted using the camera model assistance of the present disclosure, a first assisted aspect is the estimation of bounding boxes within the captures images in 805. This processing is described with respect to FIG. 9 and is visually illustrated in FIG. 10.

According to a first aspect, the camera model can be used to aid in the detection of HMD bounding box (S1) in FIG. 9. One example with two consecutive frames is shown in FIG. 10. It appears that, in the successive frames, the projected HMD bounding boxes are relatively consistent between these frames. This is due to the projected boxes P1 and P2 (dashed line boxes) being fully camera-model based and relying on IMU only. Since IMU reading is consistent across neighboring frames, the projected HMD bounding boxes (P1 and P2) show the same consistency. However, the estimated bounding boxes, E1 and E2 (solid black line boxes), differ significantly. To address this, an indicator is calculated by comparing the differences between the estimated and projected HMD bounding boxes across the two frames as shown in step S2 in FIG. 9. If the calculated indicator exceeds a predefined threshold, it is determined that the estimated bounding box is incorrect. An example of the calculations performed to calculate the indicator using the estimated box E1 and E2 is shown in Equations 2-4.

$$dE = E 1 - E 2 \qquad Equation 2$$

$$dP = P 1 - P 2 \qquad Equation 3$$

$$indicator = dE - dP \qquad Equation 4$$

Here, dE computes a first difference. The first difference is a different between a first predetermined position on each of box E1 and E2 in two neighboring frames is computed. In one embodiment, the first predetermined position is a pixel location corresponding to the right corner X (either top or bottom) position from each of estimated bounding boxes E1 and E2. In equation 3 a second difference, dP, is computed. The second difference represents the differences between second predetermined position on each of box P1 and P2 in neighboring frames. In one embodiment, the second predetermined position is a pixel location corresponding to a right corner x position (top or bottom) of projected bounding boxes P1 and P2. If the estimation is correct, these two differences should follow a similar trend, resulting in a small difference between dE and dP. Otherwise, there will be a large difference between dE and dP. Therefore, as shown in Equation 4, a difference between dE and dP, represents the indicator to identify if the estimated bounding box is correct or not. In such cases, the erroneous estimate is removed from the pipeline and replaced with more reasonable values predicted by the camera model as shown in step S4 in FIG. 9. An exemplary way to replace the erroneous estimate is shown in Equation 5

$$E 1 \_replacement = P 1 - P 2 + E 2 \qquad Equation 5$$

Here, it is assumed that dE is incorrect and it is replaced by dP since their difference should be smaller than a defined threshold for two neighboring frames. The criteria for identifying a significant estimated difference are often derived from some experiments conducted on the real captured images. In one embodiment, using 1.3 times the maximum difference found between consecutive frames in a video captured in real-world condition is used as an initial benchmark.

The above process is continuously applied to successive frames in a real-time application pipeline. In a case where a correction is performed to correct the estimate on frame 2 using the estimate on frame 1 based on the equations 2-5, the corrected estimated on frame 2 will be further used to examine the original estimate in next frame, frame 3, and correct its estimate following the above procedure if needed.

According to another aspect, the camera assist model improves the reliability of image crop processing of an image being captured such that a large enough portion of the captured image is available for bounding box detection (803 in FIG. 8).

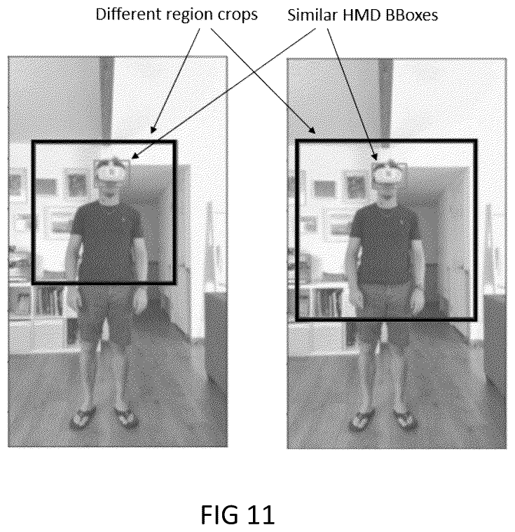

FIG. 11 illustrates how utilizing a camera model can enhance the process of image cropping (803 in FIG. 8). Image cropping is a crucial step in HMD removal because it helps to ensure that the human face and the HMD region are sufficiently large for effective HMD bounding box detection after resizing-especially when the individual moves away from the camera. Traditional image cropping techniques often rely on the background segmentation of the human figure, but these methods can be unstable due to the limitations of human segmentation models. For instance, FIG. 11 shows two consecutive frames featuring the same individual. Although there is minimal movement between the frames, the cropping region varies significantly. Note that the variation in the cropping region often leads to the instability in AI models' prediction of HMD bounding. For example, a more expansive cropping bounding box could inadvertently heighten the chance of incorrectly classifying non-target regions as part of HMD bounding box. This inconsistency in extracting cropping region can be rectified using the similar techniques we described above on camera-model guided HMD bounding box detection.

The process for extracting the cropping region using camera model is outlined in equations 6-9.

$$dE\_crop = E\_crop 1 - E\_crop 2 \qquad Equation 6$$

$$dP = P 1 - P 2 \qquad Equation 7$$

$$indicator = dE\_crop - w * dP \qquad Equation 8$$

$$E\_crop 1 \_replacement = w * ( P 1 - P 2 ) + E\_crop 2 \qquad Equation 9$$

In this context, dE_crop denotes the difference of the estimated cropping bounding boxes between neighboring frames, while dP continues to represent the difference of the projected HMD bounding boxes between neighboring frames. A weighting factor, w, is included to account for the differences between these two measures which acknowledges their relatedness yet distinct nature. The value of w is determined from trials using video captured under real-world conditions. We then follow the same logic we used in correcting HMD bounding box estimation to replace E_crop1 using E_crop1_replacement.

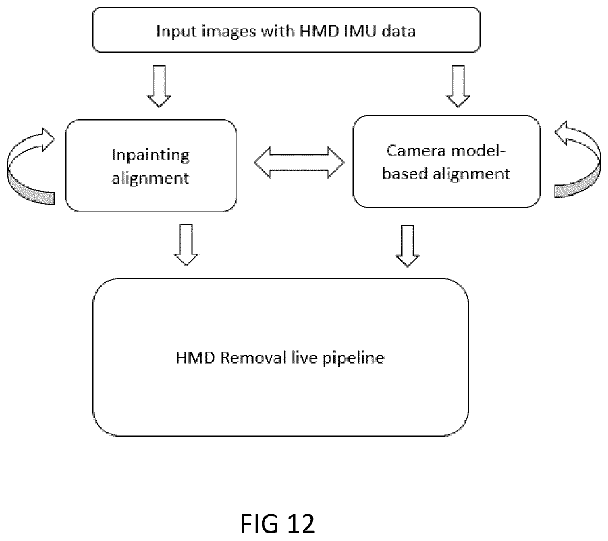

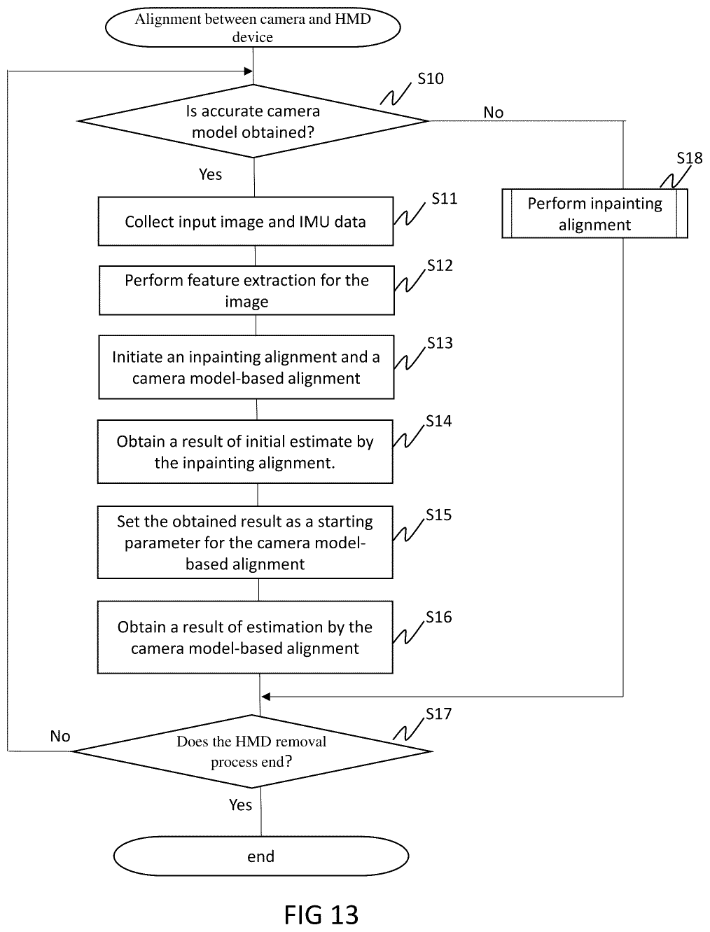

According to another aspect the camera assist model advantageously improves alignment between the image capture device (e.g. mobile phone) and the HMD device. An exemplary flow is illustrated in FIG. 12 and further described in FIG. 13 below.

The camera model will assist in aligning the camera with the HMD device. FIG. 12 provides an illustration of how the camera model is used in our pipeline for the multi-stage alignment and FIG. 13 describes the algorithmic processing. Once input images and their corresponding IMU data are collected (S11), feature extraction is performed for each image (S12). Subsequently, both inpainting and camera model-based alignment procedures are initiated (S13). The inpainting method, which typically requires a smaller dataset, offers an initial estimate of the orientation angles between the HMD and the camera (S14). This initial estimate serves as a starting parameter for the camera model-based alignment (S15). A refined estimation is then obtained through camera model alignment, utilizing a larger dataset (S16). It is important to note that this entire process is iterative and may continue throughout the duration of the HMD removal process (S17). If an accurate camera model cannot be reached in the alignment stage (No in S10), the whole HMD removal pipeline can also allow to take the parameter from inpainting alignment only (S18).

To determine if a camera model is accurate or not, the center of the HMD bounding box projected from the camera model is obtained and compared with the center of the bounding boxes estimated from the image for each frame. If the distance is larger than a threshold distance for a collected number of frames, the camera model is determined to be inaccurate. Note that there could be many different features we can extract from the bounding boxes rather than just their centers. For example, calculation of the IOU (intersection over union) between the projected bounding boxes and the estimated bounding boxes as an indicator for determining a camera model is accurate or not.

Similarly, the camera model is used to aid in the latency estimation between HMD and a camera capturing live images of a user wearing the HMD by checking the relationship between estimated HMD bounding box and projected HMD bounding box from IMU data rather than the relationship between estimated HMD bounding boxes and IMU data itself. It may also guide the background segmentation of the human figure for the entire image processing pipeline.

Similarly, the camera model assists in estimating latency between the HMD and the camera. This is achieved by examining the relationship between the estimated HMD bounding box and the projected HMD bounding box derived from IMU data, rather than solely focusing on the relationship between estimated HMD bounding boxes and the IMU data itself. This approach may also guide the background segmentation of the human figure throughout the entire image processing pipeline

According to a further aspect, the camera model can assist the HMD removal pipeline is with scaling the user image in the virtual world. In certain embodiments, scaling may be performed using a user-specified height parameter whereby the user's known physical height is entered into in image capture application that is capturing the images of the user in real-time and which are then provided to for HMD removal processing and display in the VR environment. In this embodiment, the application adjusts the size of the 2D image plane projected into the 3D virtual reality world so that the user appears at the correct height therein. This is done by determining a conversion factor from pixels in the image to meters (or the equivalent thereof) in the 3D virtual world. For example, if we know the user's full body spans 1000 rows of pixels in an image and they are known to be 1.7 meters tall, each row of pixels represents approximately 1.7/1000=0.0017 m of height, thus an image with a height of 2000 pixels would need to be projected onto a plane of height of 3.4 m to make the user appear their correct height of 1.7 m.

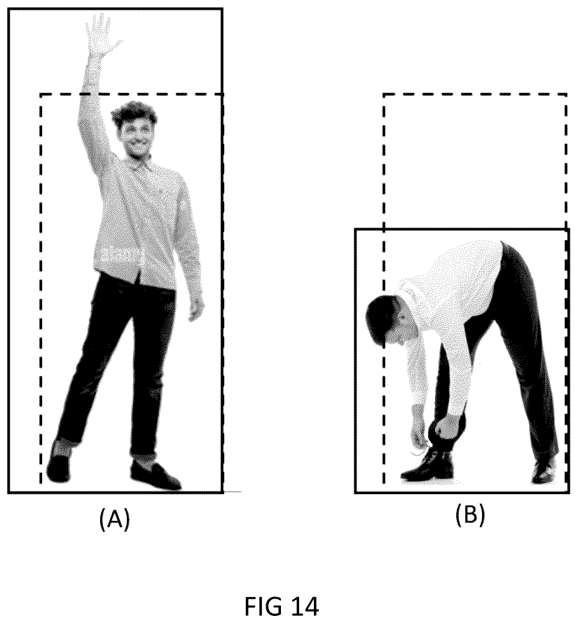

Without the camera model, the image themselves are used to determine this pixels-to-meters conversion factor (the “scale factor”), e.g., by using the alpha channel determined by a machine learning segmentation model trained to separate the foreground from the background and/or to detect a human figure in the image. But FIG. 14 illustrates limitations to using the image directly. In FIG. 14, true pixel height of the person in the image is indicated by the dashed box, while the solid box shows the height that would be detected by a segmentation model. Thus, if the user raises their hands above their head or crouches down, the number of row of pixels spanned by the user does not match their actual height and would not provide a good conversion factor. Using this method to determine the scale factor makes the user shrink incorrectly when raising their hands and grow large when crouching down, neither of which is desirable.

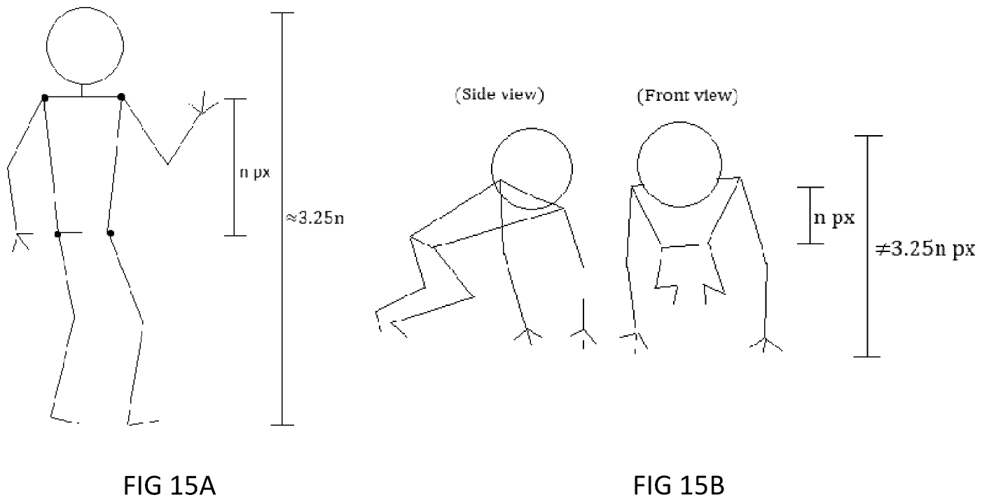

One way to ameliorate the issues caused by using the alpha channel to determine a scale factor is to make use of a more sophisticated machine learning model which is trained to determine key landmarks on the human body such as shoulders, hips, arms, and legs. If the shoulders and hips can be reliably detected, we find experimentally that the average user's height is approximately 3.25× the distance between a point in the center of their shoulders and a point in the center of their hips, as shown in FIG. 15A which can then be used to obtain a more reliable scale factor than the alpha channel alone. Even if the user raises their hands or crouches down, this distance remains largely fixed and so the scaling factor should also remain largely constant. The one exception to this would be if the user leans forward (e.g. on all fours, FIG. 15B) or backward such that they bend at the knee or waist and the back side of the user approaches the surface on which they are standing so that the apparent distance between their shoulders and hips is smaller than in reality due to the 2D nature of the image. Landmark detection models have difficulty inferring depth information for each of the landmarks and the resulting estimation is unreliable and/or noisy.

The camera model assist can be used directly to determine a scale factor by projecting two points of known physical separation into the image plane and measuring the resulting pixel separation. For example, if we project two points separated by a distance of e.g. 1 m along a vector parallel to the camera's sensor anchored to a point at the known distance the user is from the camera, we have an exact measurement that can then be converted to a scale factor. A drawback here is the need for an accurate camera model, which may not be achievable in every instance. In practice the scale factor from the determined camera model may have a different magnitude than the scale factor(s) determined using the alpha channel and/or some landmark detection model due to incorrectly determined camera model parameters such as the distance the user is from the camera or the focal length/intrinsic scale of the camera. When the user moves away from the camera, all methods tend to show an increase in the scale factor, and when they move toward the camera, all methods tend to show a decrease in the scale factor. However, since the camera model is based on IMU data coming from the headset, its scale factors are much less noisy than those from the alpha channel or landmark detection models. As such, we describe herein a method of imparting the camera model's smoothness onto the scale factors determined by one of the other methods, or of any similar method, correcting its magnitude to account for any error in the determined camera model parameters.

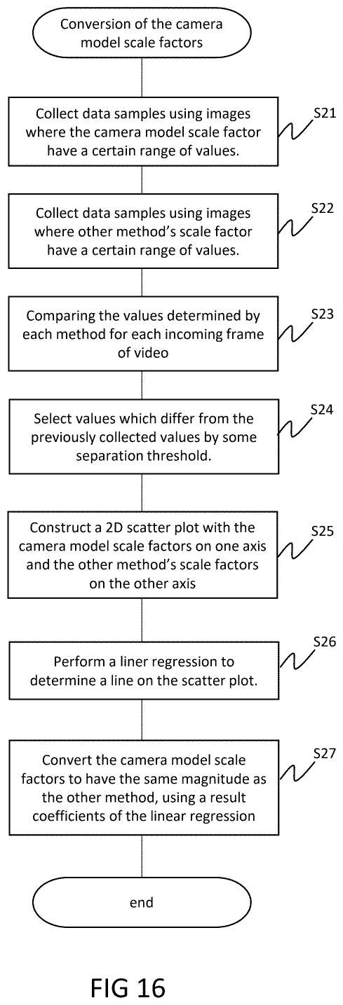

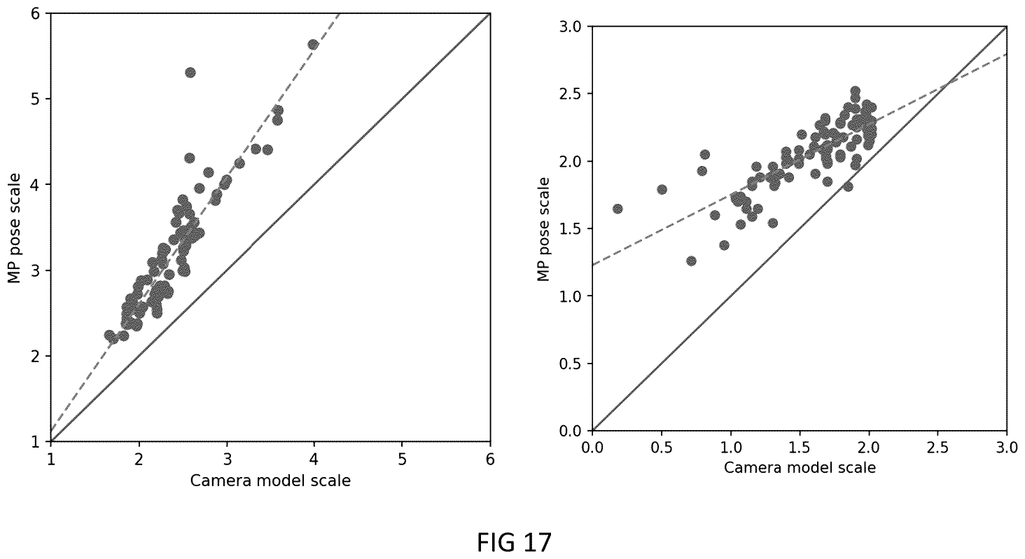

The flow diagram of FIG. 16 describes the associated processing algorithm. Processing begins by collecting a number of data samples using images where the determined camera model scale factor and the scale factors from the other method have a reasonably wide range of values (S21 and S22). This can be achieved by comparing the values determined by each method for each incoming frame of video (S23) and only selecting values which differ from the previously collected values by some minimum separation threshold (S24). Once enough points have been collected, a 2D scatter plot is constructed shown in FIG. 17 from two experiments with the camera model scale factors on the horizontal axis and the other method's scale factors on the vertical axis (S25). These should generally have a linear correlation as demonstrated on both the left and right figures from two different experiments and thus a linear regression can be performed to determine a line of best fit (S26). Once this linear regression has been performed, the result coefficients, namely the slope and intercept, can be used to linearly convert the camera model scale factors to have the same magnitude as the other method (S27). With this conversion, the smoothness of the camera model can be retained as well as the accurate magnitude of the other method.

The present disclosure describes a plurality of image processing methods that are implemented by one or more server apparatuses and may be included in a system that includes an image capture device, a head mount display device and at least one server or information processing apparatus.

In one embodiment, the presently disclosed image processing methods include processing operations that are performed as a result of at set of computer readable instructions (e.g. program(s)) being executing by one or more processors of a computing device such as a server. In one embodiment, the method includes receiving two consecutive image frames captured live by an image capture apparatus, each of the two image frames including a subject wearing a head mount display device, generate a first bounding box surrounding the head mount display device using orientation information obtained from the head mount display, generate a second bounding box surrounding the head mount display using an object detection model trained to identify the head mount display, calculate a difference indicator by comparing differences, on a pixel by pixel basis between the generated first and second bounding boxes, select the first bounding box when it is determined that the difference indicator exceeds a predetermined threshold, provide coordinates representing the first bounding box to identify a region within the images to be replaced by a region of a precaptured image that is occluded by the head mount display device.

In certain embodiments, the operations of generating the first bounding box is performed using a camera model describing characterizing a relationship between the head mount display device in three dimensions and a two dimensional image projection of the head mount display device.

In another embodiment, alignment processing is also performed and includes aligning a first coordinate system with a second coordinate system by receiving an image frame of a subject wearing a head mount display device, determine a first alignment parameter that aligns the first coordinate system with the second coordinate system based on replacing a portion of the subject occluded by the head mount display device with features of the subject derived from a precaptured image, determining a second alignment parameter using the first alignment parameter as an initial value and using a camera model, determine whether the second alignment parameter is valid by determining an accuracy of the camera model; and use the second alignment parameter when it is determined that the camera model is accurate and use the first alignment parameter when it is determined that the camera model is not accurate.

In a further embodiment, scaling processing is performed includes scaling an image in a virtual reality environment by obtaining a plurality of images having a first scale factor determined using a camera model, obtaining a plurality of image having a second scale factor using a scaling model other than a camera model, comparing values of the first and second scale factors, generating a plot representing first and second scale factors that differ by a predetermined threshold, converting the first scale factor to have a magnitude substantially similar to a magnitude of the second scale factor based on a linear regression of the generated plot; and display the images in the virtual reality environment using the converted scale factor.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

We claim:

1. An image processing method comprising:
receiving at least two consecutive image frames captured live by an image capture apparatus, each of the at least two image frames including a subject wearing a head mount display device;
generating a first bounding box surrounding the head mount display device using orientation information obtained from the head mount display;
generating a second bounding box surrounding the head mount display using an object detection model trained to identify the head mount display;
calculating a difference indicator by comparing differences, on a pixel by pixel basis between the generated first and second bounding boxes;
selecting the first bounding box when it is determined that the difference indicator exceeds a predetermined threshold;
providing coordinates representing the first bounding box to identify a region within the images to be replaced by a region of a precaptured image that is occluded by the head mount display device.

2. An image processing method according to claim 1, wherein generating the first bounding box is performed using a camera model characterizing a relationship between the head mount display device in three dimensions and a two dimensional image projection of the head mount display device.

3. The method according to claim 1, further comprising:
using the provided coordinates to replace the identified region with a corresponding region of the precaptured image; and
generating a composite image that includes the subject appearing without the head mount display device and including the replaced region from the precaptured image.

4. The method according to claim 1 further comprising:
aligning a first coordinate system associated with an image capture device with a second coordinate system associated with the head mount display device; and
using the aligned coordinate systems in replacing a portion of the image frame that includes the head mount display device with a region of a precaptured image of the subject.

5. The method according to claim 4, wherein the operation of aligning further comprises:
receiving an image frame of a subject wearing a head mount display device;
determining a first alignment parameter that aligns the first coordinate system with the second coordinate system based on replacing a portion of the subject occluded by the head mount display device with features of the subject derived from a precaptured image;
determining a second alignment parameter using the first alignment parameter as an initial value and using a camera model;
determining whether the second alignment parameter is valid by determining an accuracy of the camera model; and
using the second alignment parameter when it is determined that the camera model is accurate and use the first alignment parameter when it is determined that the camera model is not accurate.

6. The method according to claim 1, further comprising:
generating a composite image that includes the subject appearing without the head mount display device and including the replaced region from the precaptured image; and
scaling the generated image to appear correctly proportional to an image in a shared virtual reality environment;
causing the scaled image to be displayed on a display of the head mount display being worn by the subject and on the head mount display of other subjects concurrently in the virtual reality environment.

7. The method according to claim 6, wherein the operation of scaling an image further comprises:
obtaining a plurality of images having a first scale factor determined using a camera model;
obtaining a plurality of image having a second scale factor using a scaling model other than a camera model;
comparing values of the first and second scale factors;
generating a plot representing first and second scale factors that differ by a predetermined threshold;
converting the first scale factor to have a magnitude substantially similar to a magnitude of the second scale factor based on a linear regression of the generated plot; and
causing the scaled images to be displayed in the shared virtual reality environment using the converted scale factor.

8. An information processing apparatus comprising
one or more memories storing instructions; and
one or more processors that, upon execution of the stored instructions, are configured to cause the one or more processors to:
receive at least two consecutive image frames captured live by an image capture apparatus, each of the at least two image frames including a subject wearing a head mount display device;
generate a first bounding box surrounding the head mount display device using orientation information obtained from the head mount display;
generate a second bounding box surrounding the head mount display using an object detection model trained to identify the head mount display;
calculate a difference indicator by comparing differences, on a pixel by pixel basis between the generated first and second bounding boxes;
select the first bounding box when it is determined that the difference indicator exceeds a predetermined threshold;
provide coordinates representing the first bounding box to identify a region within the images to be replaced by a region of a precaptured image that is occluded by the head mount display device.

9. The information processing apparatus according to claim 8, wherein execution of the stored instructions further configures the one or more processors to generate the first bounding box is performed using a camera model characterizing a relationship between the head mount display device in three dimensions and a two dimensional image projection of the head mount display device.

10. The information processing apparatus according to claim 8, wherein execution of the stored instructions further configures the one or more processors to:
use the provided coordinates to replace the identified region with a corresponding region of the precaptured image; and
generate a composite image that includes the subject appearing without the head mount display device and including the replaced region from the precaptured image.

11. The information processing apparatus according to claim 8, wherein execution of the stored instructions further configures the one or more processors to:
align a first coordinate system associated with an image capture device with a second coordinate system associated with the head mount display device; and
use the aligned coordinate systems in replacing a portion of the image frame that includes the head mount display device with a region of a precaptured image of the subject.

12. The information processing apparatus according to claim 11, wherein execution of the stored instructions further configures the one or more processors to:
receive an image frame of a subject wearing a head mount display device;
determine a first alignment parameter that aligns the first coordinate system with the second coordinate system based on replacing a portion of the subject occluded by the head mount display device with features of the subject derived from a precaptured image;
determine a second alignment parameter using the first alignment parameter as an initial value and using a camera model;
determine whether the second alignment parameter is valid by determining an accuracy of the camera model; and
use the second alignment parameter when it is determined that the camera model is accurate and use the first alignment parameter when it is determined that the camera model is not accurate.

13. The information processing apparatus according to claim 8, wherein execution of the stored instructions further configures the one or more processors to:
generate a composite image that includes the subject appearing without the head mount display device and including the replaced region from the precaptured image; and
scale the generated image to appear correctly proportional to an image in a shared virtual reality environment;
cause the scaled image to be displayed on a display of the head mount display being worn by the subject and on the head mount display of other subjects concurrently in the virtual reality environment.

14. The information processing apparatus according to claim 13, wherein execution of the stored instructions further configures the one or more processors to:
obtain a plurality of images having a first scale factor determined using a camera model;
obtain a plurality of image having a second scale factor using a scaling model other than a camera model;
compare values of the first and second scale factors;
generate a plot representing first and second scale factors that differ by a predetermined threshold;
convert the first scale factor to have a magnitude substantially similar to a magnitude of the second scale factor based on a linear regression of the generated plot; and
cause the scaled images to be displayed in the shared virtual reality environment using the converted scale factor.

15. A system comprising:
a head mount display device configured to be worn by a subject;
an image capture device configured to capture real time images of the subject wearing the head mount display device; and
an information processing apparatus one or more memories storing instructions; and one or more processors that, upon execution of the stored instructions, are configured to cause the one or more processors to:
receive at least two consecutive image frames captured live by an image capture apparatus, each of the at least two image frames including a subject wearing a head mount display device;
generate a first bounding box surrounding the head mount display device using orientation information obtained from the head mount display;
generate a second bounding box surrounding the head mount display using an object detection model trained to identify the head mount display;
calculate a difference indicator by comparing differences, on a pixel by pixel basis between the generated first and second bounding boxes;
select the first bounding box when it is determined that the difference indicator exceeds a predetermined threshold;
provide coordinates representing the first bounding box to identify a region within the images to be replaced by a region of a precaptured image that is occluded by the head mount display device.

16. The system according to claim 15, wherein the information processing apparatus is further configured to generate the first bounding box is performed using a camera model characterizing a relationship between the head mount display device in three dimensions and a two dimensional image projection of the head mount display device.

17. The system according to claim 15, wherein the information processing apparatus is further configured to:
use the provided coordinates to replace the identified region with a corresponding region of the precaptured image; and
generate a composite image that includes the subject appearing without the head mount display device and including the replaced region from the precaptured image.

18. The system according to claim 15, wherein the information processing apparatus is further configured to
align a first coordinate system associated with an image capture device with a second coordinate system associated with the head mount display device; and
use the aligned coordinate systems in replacing a portion of the image frame that includes the head mount display device with a region of a precaptured image of the subject.

19. The system according to claim 15, wherein the information processing apparatus is further configured to:
generate a composite image that includes the subject appearing without the head mount display device and including the replaced region from the precaptured image; and
scale the generated image to appear correctly proportional to an image in a shared virtual reality environment;
cause the scaled image to be displayed on a display of the head mount display being worn by the subject and on the head mount display of other subjects concurrently in the virtual reality environment.
